(19) United States
(12) Patent Application Publication
(10) Pub. No.: US 2002/0082855 A1
(43) Pub. Date: Jun. 27, 2002

(54) Pet death care products and method of providing pet death care products, services and information

(76) Inventors: Bradley Jade Dickey, Batesville, IN (US); Rodger Allen Jones, Indianapolis, IN (US); Chris Lowery, Batesville, IN (US); Darryl M. Maslar, Batesville, IN (US)

Correspondence Address: WOOD, HERRON & EVANS, L.L.P., 2700 Carew Tower, Cincinnati, OH, 45202, US

(21) Appl. No.: 09/909,921

(22) Filed: Jul. 20, 2001

Related U.S. Application Data
(60) Provisional application No. 60/219,675, filed on Jul. 21, 2000.

(51) Int. Cl. G06F 17/60; A61G 17/00

(52) U.S. Cl. 705/1; 705/27; 27/1

(57) ABSTRACT

A method of providing pet death care products, services and information comprises receiving pet death care products, services and information from a supplier, and, as a preferred provider, dispensing the pet death care products, services and information to pet owners. A method of equipping a preferred provider with pet death care products, services and information to be dispensed to pet owners comprises selecting a preferred provider and supplying the preferred provider with pet death care products, services and information to be dispensed by the preferred provider to pet owners. Preferably the preferred provider is an individual veterinarian or a network of veterinarians. Optionally the preferred provider could be an individual pet store or a nationwide chain or franchise of pet stores, or an individual pet cemetery or a nationwide chain of pet cemeteries. The preferred provider would offer the pet owner such products as pet caskets, urns, memorial markers and products, etc., and grief consoling printed matter such as children's brochures or coloring books dealing with pet loss, etc. The preferred provider would also offer the pet owner such disposition services as cremation and burial, and funeral or other memorial services, etc. The preferred provider would further offer the pet owner information about grief counseling and death/grief support groups, etc.

### RELATED APPLICATIONS

This application is a continuation-in-part of application Ser. No. 60/219,675, hereby incorporated by reference herein.

### FIELD OF THE INVENTION

This invention relates generally to the death care industry, and more particularly to the pet death care industry and the products, services and information therefore and the methods and means of providing same.

### BACKGROUND OF THE INVENTION

Pet death care is a growing industry. Pet owners become closely attached to their pets, not unlike the way friends and family become closely attached to one another. As a consequence, there is a need for pet owners to grieve when their pets die and to memorialize the pet after death.

Currently there is no comprehensive system or approach to providing pet owners with pet loss products, services and information upon the death of their pets. Families, senior citizens and especially children all develop close personal relationships with their pets. As a consequence, when their pets die, there is a need to provide them aftercare information, guidance and counseling in much the same manner as is provided to family and friends of a deceased loved one. Information in the areas of aftercare, i.e. cremation and burial, and memorialization, i.e. vaults, caskets, urns, memorial markers and other memorial products, and grief counseling are desired. The difficulty is that current offerings of such information are extremely fragmented and not systematically centralized. As a result, obtaining such information and guidance is difficult and bothersome, difficulty and bother being of course the last things a grieving pet owner needs to be subjected to at the time of pet loss.

### SUMMARY OF THE INVENTION

The present invention provides a number of pet death care products as well as methods of providing pet death care products, services and information and of equipping a preferred provider with pet death care products, services and information to be dispensed to pet owners. The method of providing pet death care products, services and information comprises receiving pet death care products, services and information from a supplier, and, as a preferred provider, dispensing the pet death care products, services and information to pet owners. The method of equipping a preferred provider with pet death care products, services and information to be dispensed to pet owners comprises selecting a preferred provider and supplying the preferred provider with pet death care products, services and information to be dispensed by the preferred provider to pet owners. Preferably the preferred provider is an individual veterinarian or a network of veterinarians. Optionally the preferred provider could be an individual pet store or a nationwide chain or franchise of pet stores. Again optionally the preferred provider could be an individual pet cemetery or a nationwide chain of pet cemeteries.

The preferred provider would offer the pet owner such products as pet caskets, urns, memorial markers and products, etc., and grief consoling printed matter such as children's brochures or coloring books dealing with pet loss, etc. The preferred provider would also offer the pet owner such disposition services as cremation and burial, and funeral or other memorial services, etc. The preferred provider would further offer the pet owner information about grief counseling and death/grief support groups, etc.

The present invention thus provides a much needed centralized, systematic approach to dispensing pet death care products, services and information, as well as new and novel pet death care products.

These and other features and advantages of the present invention will become more readily apparent during the following detailed description taken in conjunction with the drawings herein, in which:

### BRIEF DESCRIPTION OF THE DRAWINGS OF THE INVENTION

FIG. 1 is a flowchart of a method of dispensing pet death care products, services and information according to the principles of the present invention;

FIG. 2 is a block diagram of a World Wide Web Internet site of content for use in dispensing pet death care products, services and information according to the method of FIG. 1;

FIG. 3 is a pet product catalog of FIG. 2;

FIGS. 4 and 5 are pet caskets from the FIG. 3 catalog;

FIGS. 6-13 are pet urns from the FIG. 3 catalog;

FIG. 14 is a pet memorial plaque from the FIG. 3 catalog;

FIGS. 15-17 are pet memorial frames from the FIG. 3 catalog;

FIG. 18 is a pet garden memorial stepping stone from the FIG. 3 catalog;

FIG. 19 is pet figurines from the FIG. 3 catalog;

FIG. 20 is a pet memento chest from the FIG. 3 catalog;

FIG. 21 is pet sympathy cards from the FIG. 3 catalog;

FIG. 22 is a pet memorial mouse pad and a pet photo album from the FIG. 3 catalog;

FIG. 23 is pet loss brochures from the FIG. 2 website; and

FIGS. 24-27 are retail pet memorial product displays.

### DETAILED DESCRIPTION OF THE INVENTION

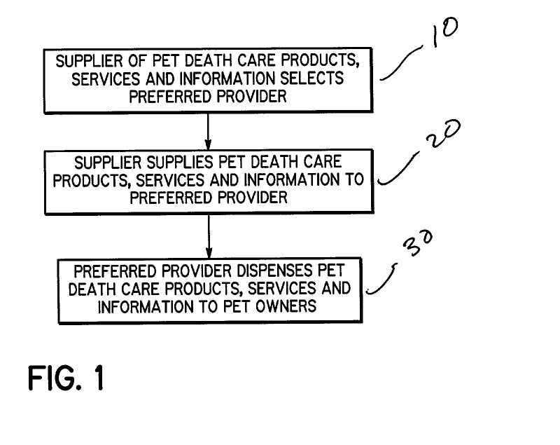

Referring first to FIG. 1, there is illustrated a flow chart of a method of dispensing pet death care products, services and information according to the principles of the present invention. The FIG. 1 method comprises an initial step 10 wherein the supplier of the pet death care products, services and information selects a preferred provider to provide or dispense such products, services and information to pet owners. In a second step 20 the supplier supplies the pet death care products, services and information to the preferred provider selected in step 10. Finally, in step 30 the preferred provider dispenses the pet death care products, services and information to the pet owners. The preferred provider can be an individual veterinarian or a network of veterinarians, an individual pet store or a nationwide chain or franchise of pet stores, or an individual pet cemetery or a nationwide chain of pet cemeteries. The preferred provider would offer the pet owners such products as pet caskets, urns, memorial markers and products, etc., and grief consoling printed matter such as children's brochures or coloring books dealing with pet loss, etc. The preferred provider would also offer the pet owner such disposition services as cremation and burial, and funeral or other memorial services, etc. The preferred provider would further offer the pet owner information about grief counseling and death/grief support groups, etc.

The cremation services offered to pet owners could be made available through any of four sources of such services. First, pet cremations could be performed utilizing a crematory owned by the supplier of the pet death care products, services and information, for example the Assignee of the present invention. Second, pet cremations could be performed in a crematory owned by a humane society. A percentage of the fees collected for the cremations could be paid to the humane society in return for use of the excess capacity of their crematory. In addition, the supplier and the humane society could “co-brand” to leverage both presences with veterinarians and consumers. The scope of informational materials provided could be broadened to include information regarding pet adoption, pet adoption services available through the humane society and information regarding responsible pet ownership. Third, pet cremations could be performed in a crematory owned by a direct competitor of the supplier of pet death care products, services and information. A percentage of the fees collected for the cremations could be paid to the competitor in return for use of the excess capacity of their crematory. Fourth, pet cremations could be performed in a crematory owned by a retort manufacturer. A percentage of the fees collected for cremations could be paid to the retort manufacturer instead of purchasing the retort equipment directly.

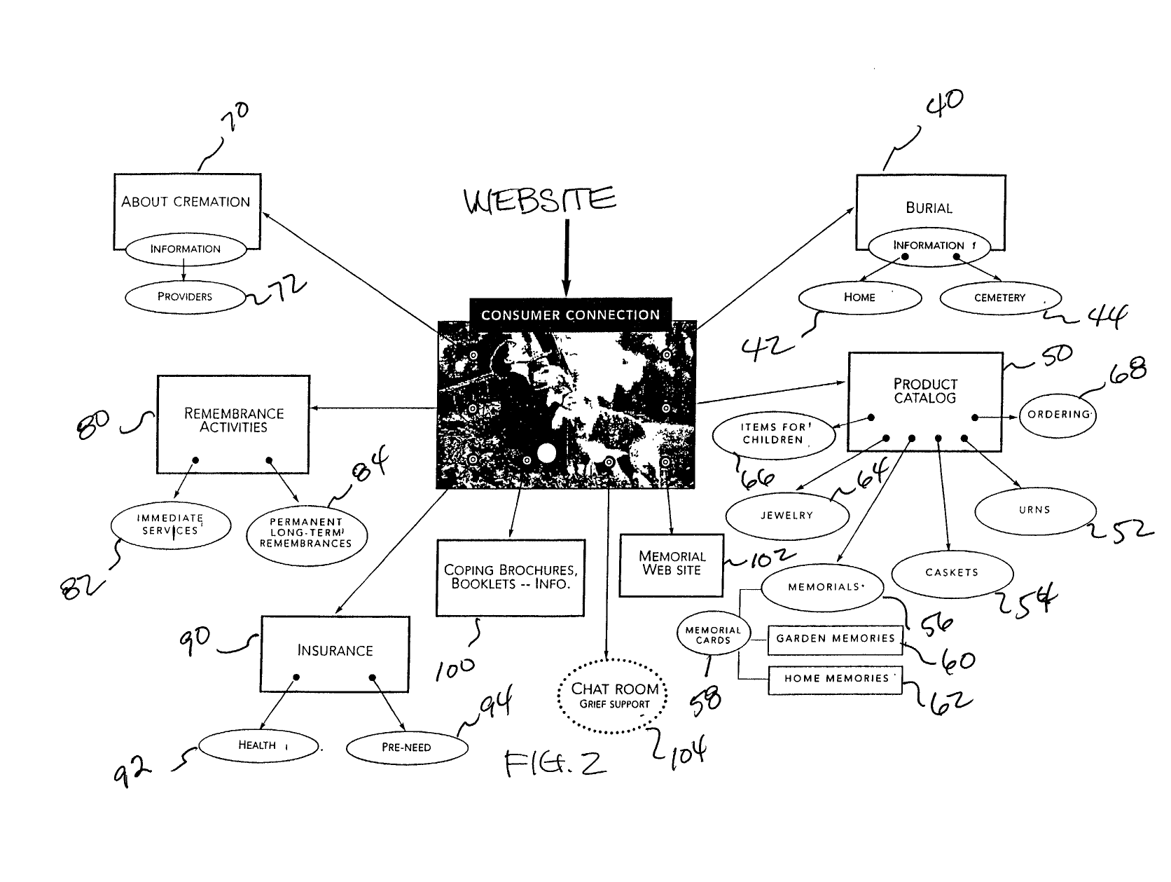

Referring now to FIG. 2, there is illustrated a block diagram of a World Wide Web internet site of content for use in dispensing the pet death care products, services and information according to the method of FIG. 1. The web site content can include pet burial information 40 including home burial information 42 and cemetery burial information 44. The web site content can also include a pet product catalog 50 which could include a selection of cremation urns 52, caskets 54, memorials 56 including cards 58, garden memories 60 and home memories 62, jewelry 64, children's items 66 and ordering information 68. The content may further include pet cremation information 70 including providers thereof 72. The content may further include remembrance activities 80 such as immediate services 82 and permanent long-term remembrances 84. The content may further include insurance information 90 including pet health insurance 92 and pet pre-need funeral insurance 94. Additional web site content could include coping brochures, booklets and the like 100, a memorial web site 102 and a chat room 104 providing grief support.

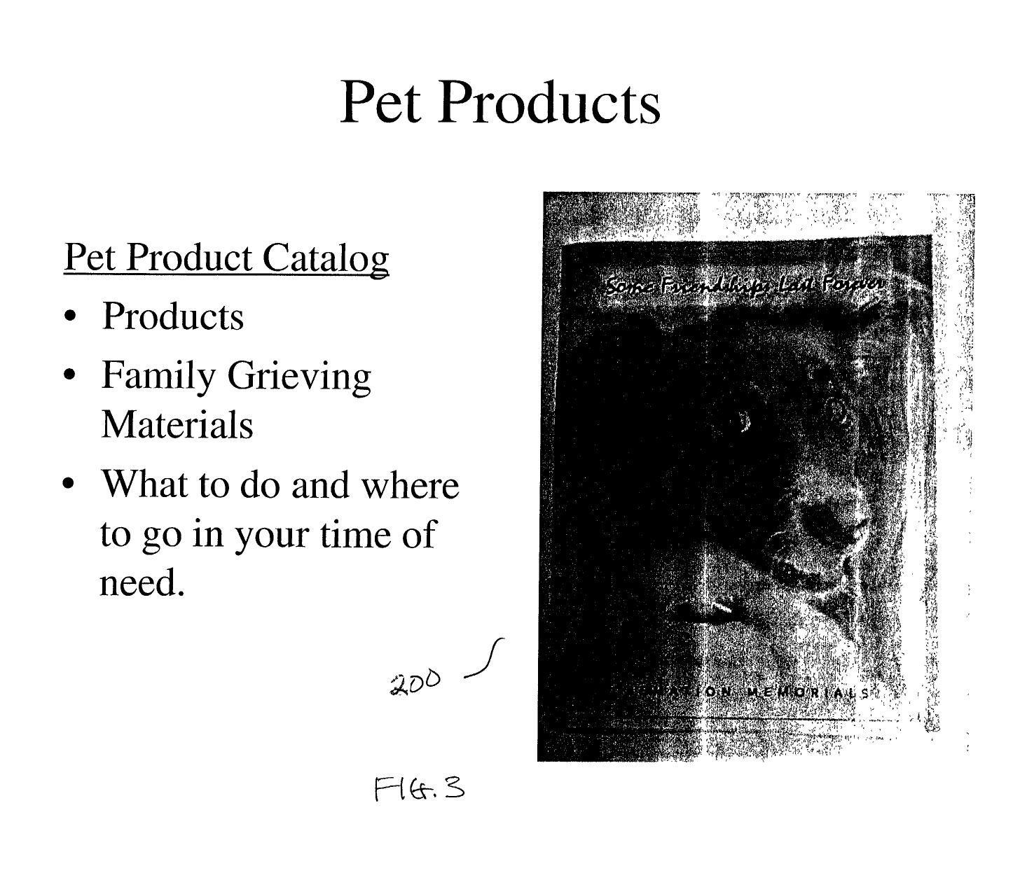

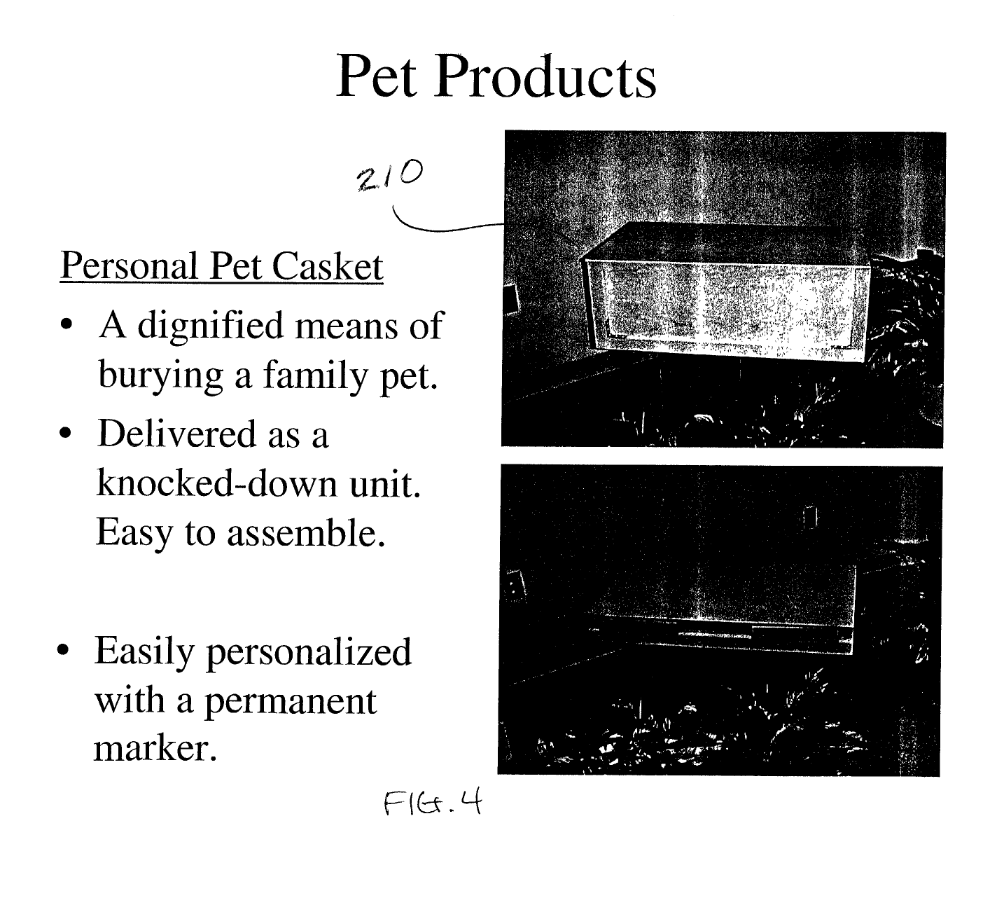

Referring to FIG. 3 there is illustrated a pet catalog 300 from the content of the FIG. 2 World Wide Web internet site. The pet catalog 300 could include products, family grieving materials, and other information such as what to do and where to go in one's time of need. FIGS. 4-23 illustrate a number of such products, materials and information.

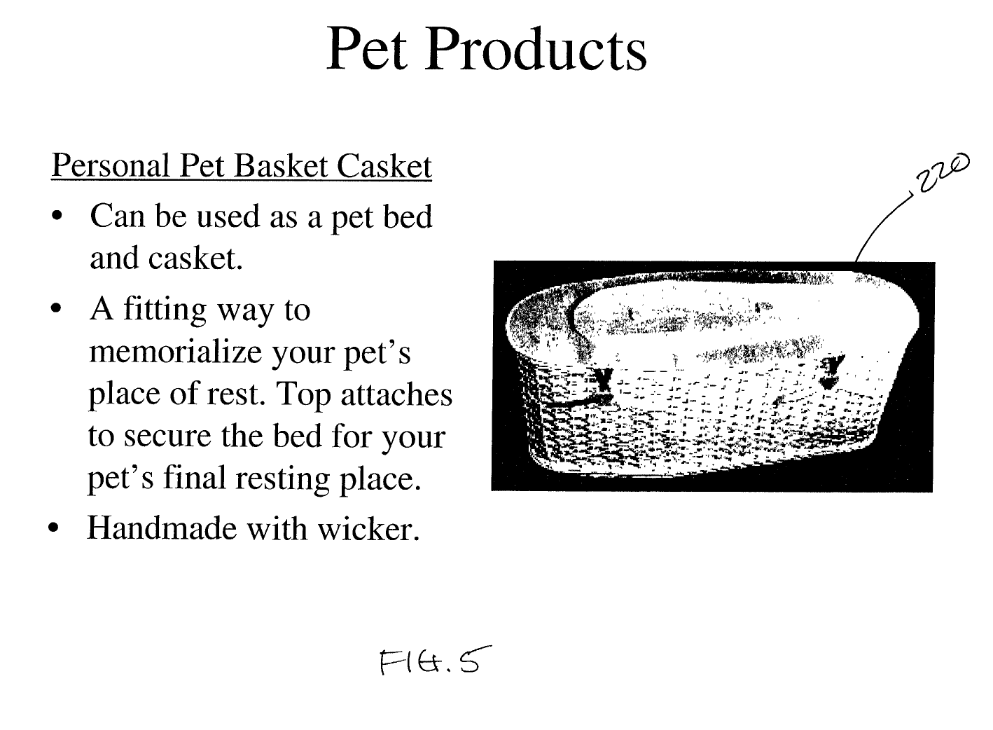

For example, FIGS. 4 and 5 are pet caskets from the FIG. 3 catalog. FIG. 4 is a so-called knock down unit 210 which is shipped in a knocked down state and is assembled on site. The unit 210 provides a dignified means of burying a family pet, and is easily personalized with a permanent marker. FIG. 5 illustrates another pet casket, a so-called pet basket casket, handmade of wicker, which can be used as a pet bed and casket. A top attaches to the lower bed portion to form the casket.

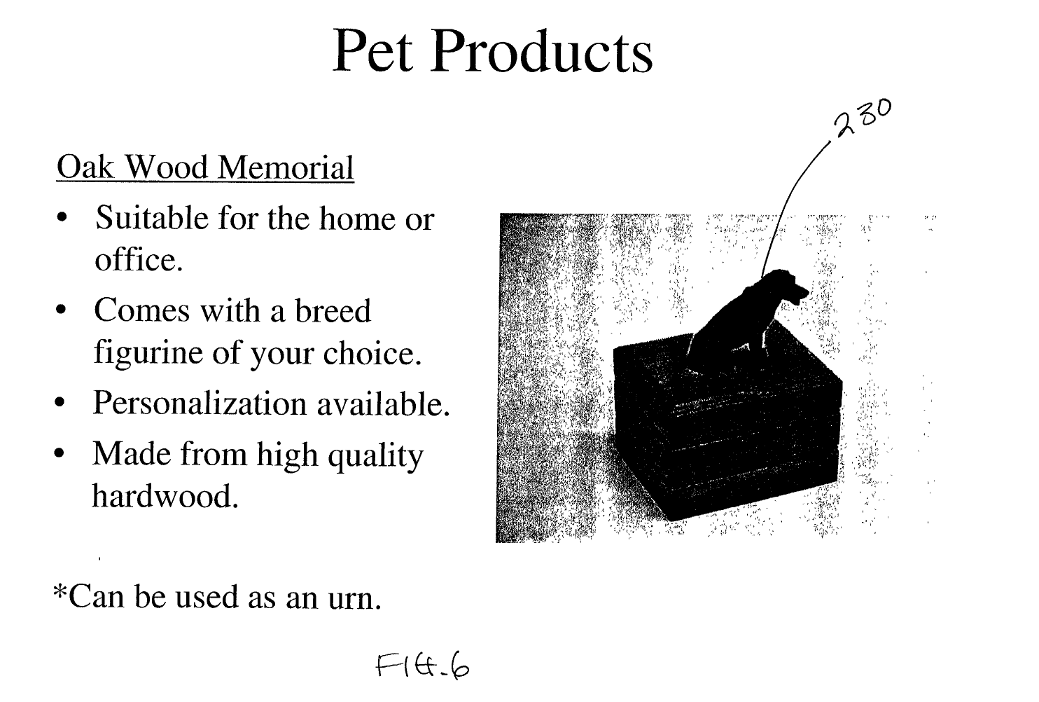

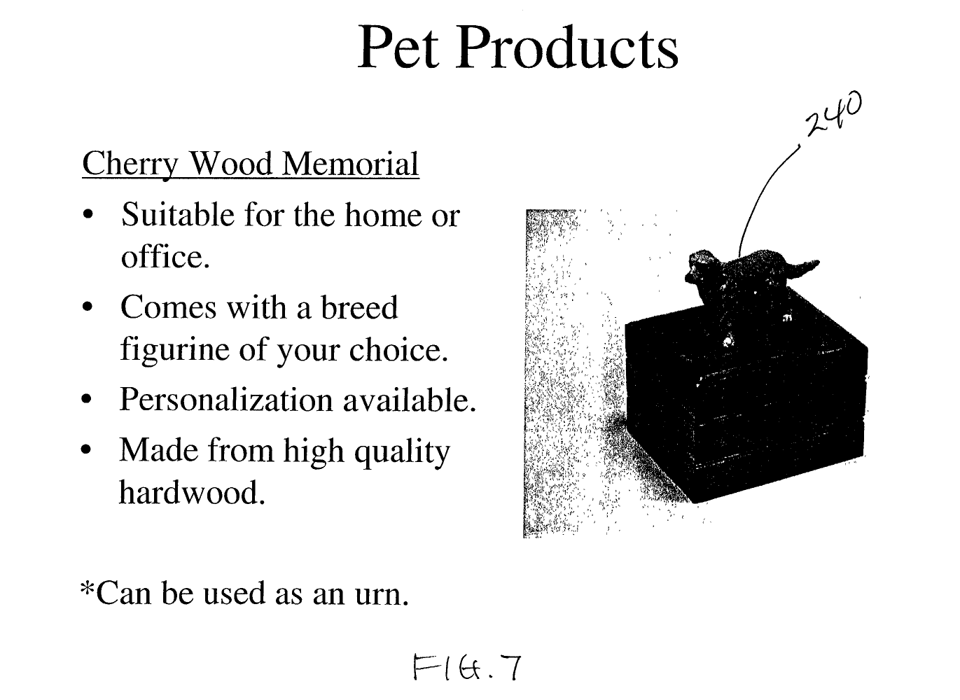

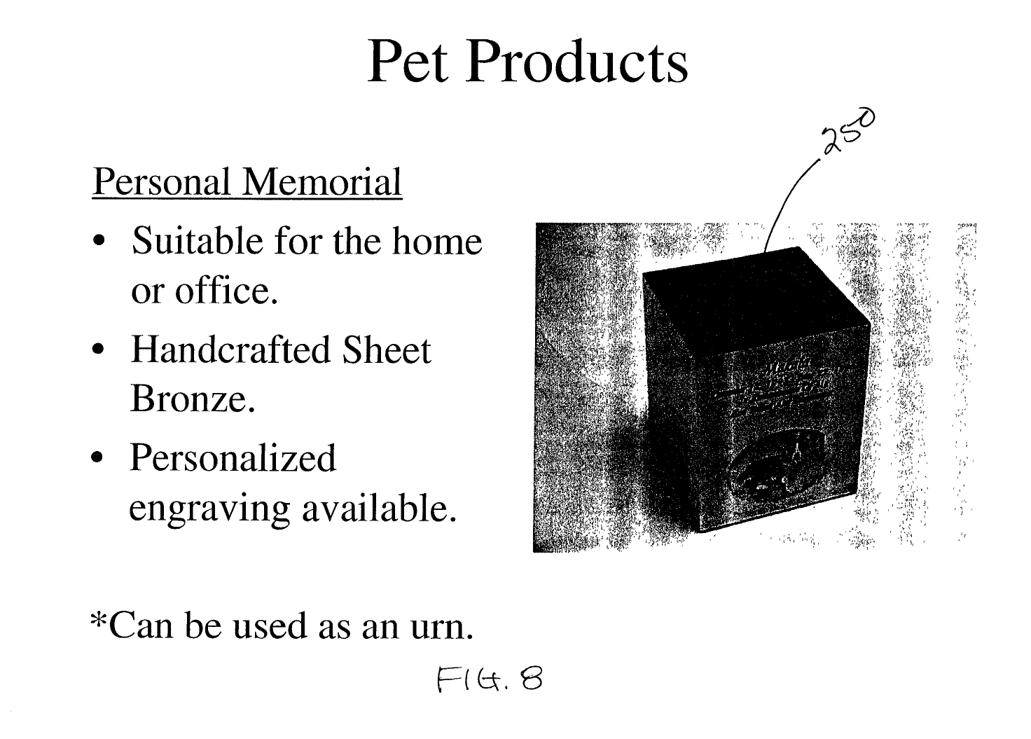

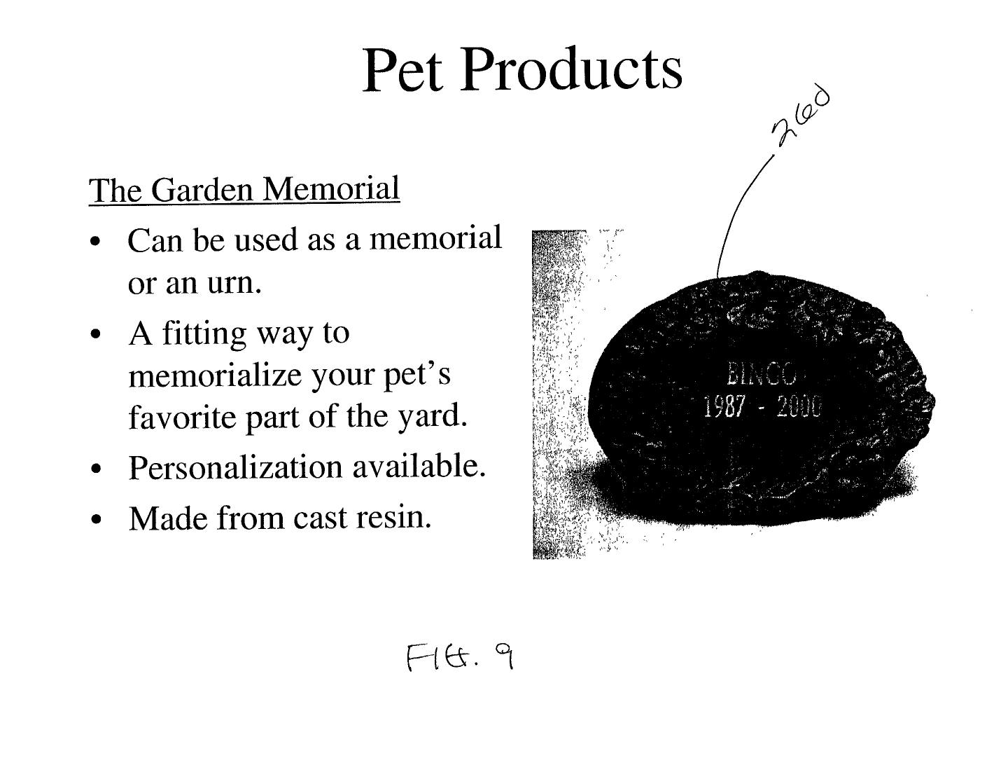

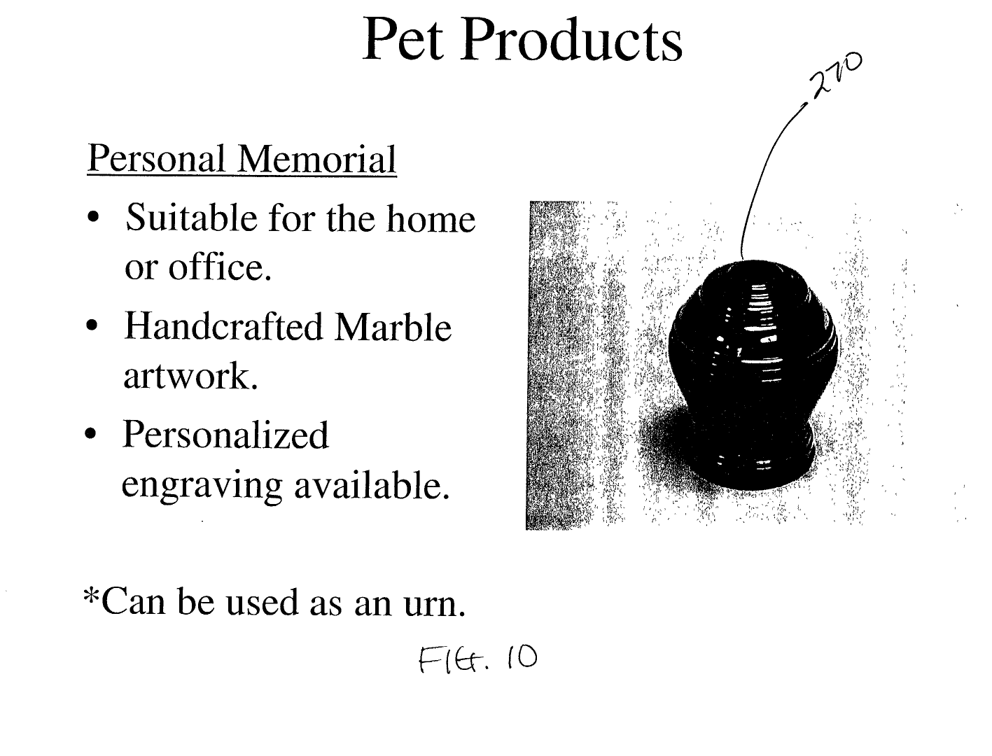

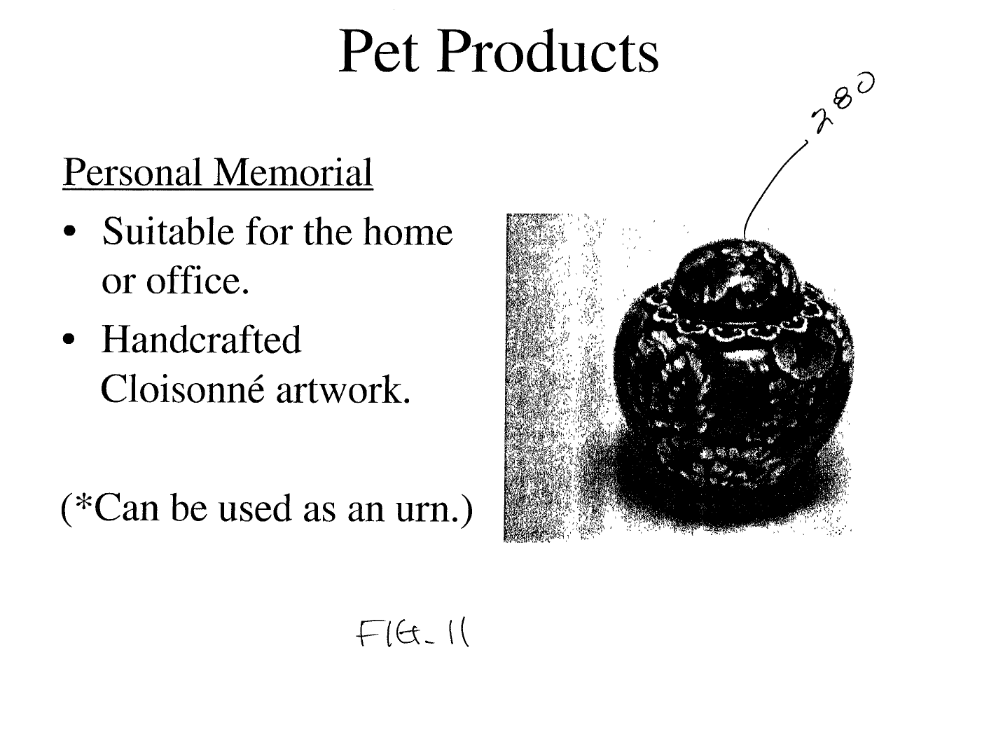

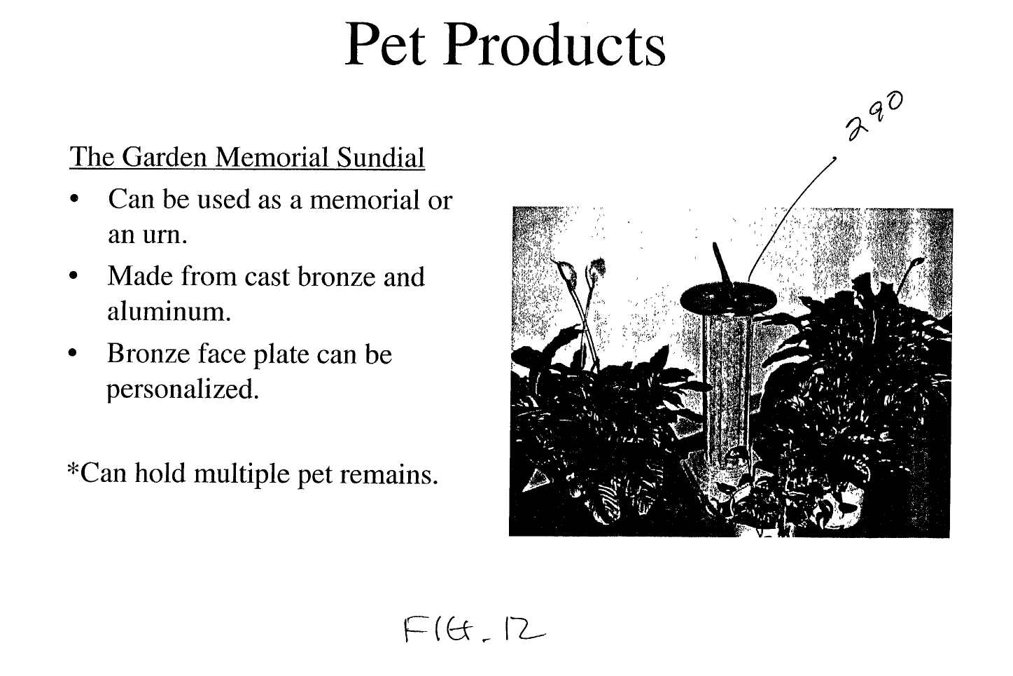

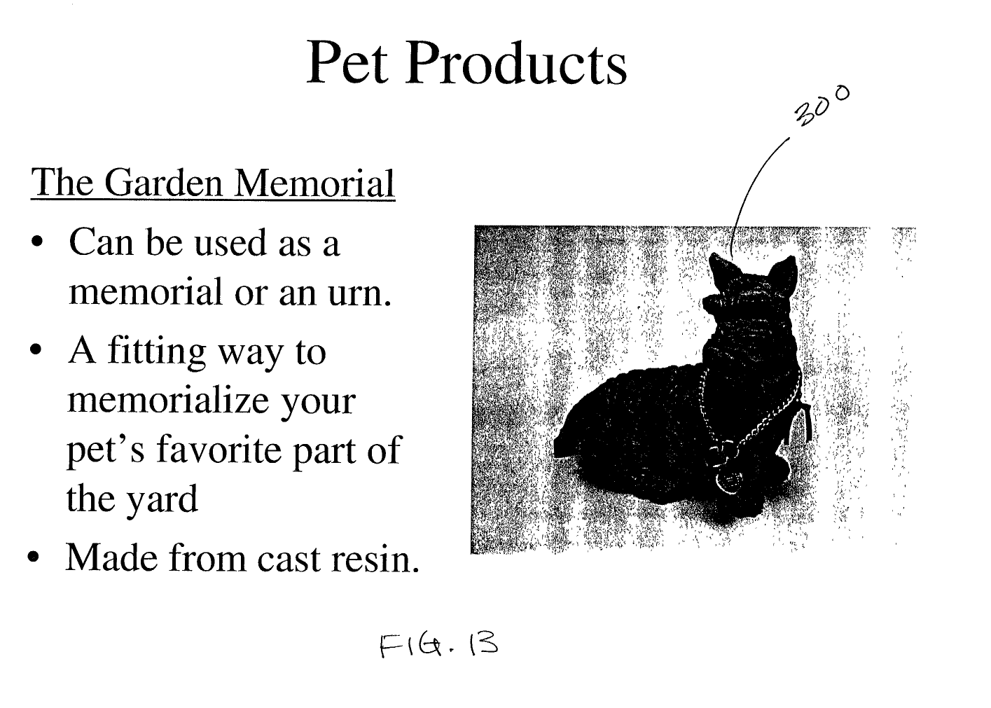

FIGS. 6-13 are pet urns from the FIG. 3 catalog. The FIG. 6 urn 230 is made from high quality hard wood, for example oak, and is suitable for the home or office. The urn 230 comes with the dog breed figurine of one's choice, and personalization is available. The FIG. 7 urn 240 is similar to the FIG. 6 urn 230 except that the urn 240 is cherry instead of oak. The FIG. 8 urn 250 is hand crafted of sheet bronze. Like the urns 230 and 240, it can be personalized, i.e. engraved, and is also suitable for home or office. The FIG. 9 urn 260 is made from cast resin, and can be used as a memorial, an urn or both, such as for example in one's garden. Like the prior urns, the urn 260 can be personalized and it is a fitting way to memorialize one's pet's favorite part of the yard. The FIG. 10 urn 270 is hand crafted of marble. Like the other urns, the urn 270 is personalizable via engraving and is suitable for the home or office. The FIG. 11 urn 280 is similar to the urn 270 but is hand crafted of cloisonné. The FIG. 12 urn 290 is made of cast bronze and aluminum and can be used as a memorial, urn, or both, preferably in one's garden. The urn 290 includes a bronze face plate that can be personalized through engraving. Finally, FIG. 13 illustrates an urn 300 made from cast resin that can also be utilized as a memorial, urn, or both, again preferably in one's garden, and is a fitting way to memorialize one's pet's favorite part of the yard.

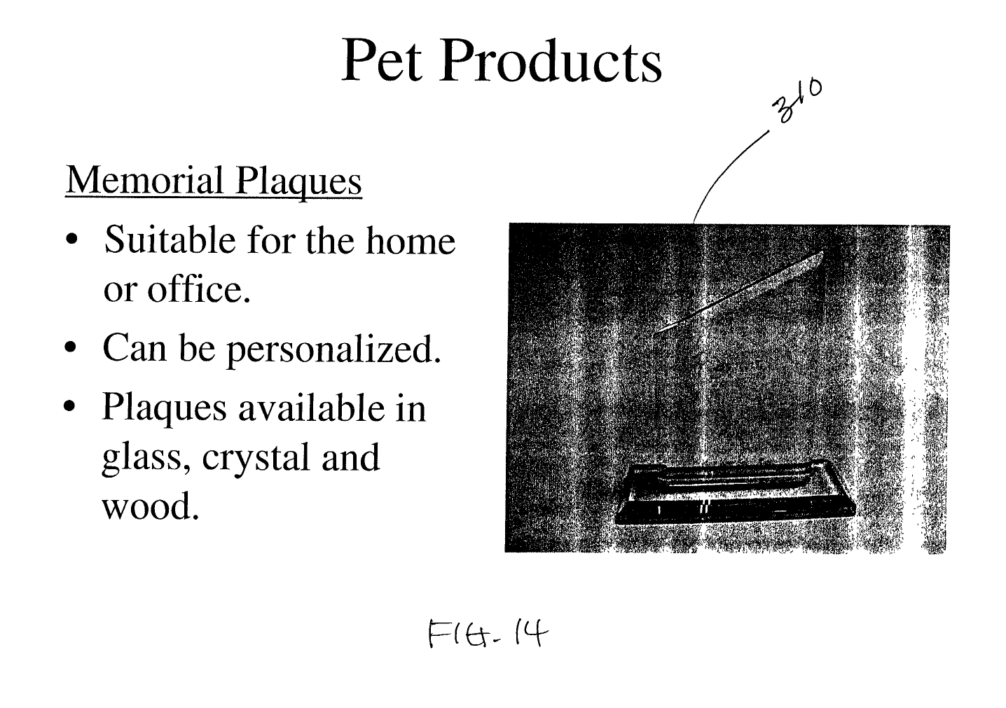

FIG. 14 is a memorial plaque 310 made of glass, crystal and wood. The plaque can be personalized and is suitable for home or office.

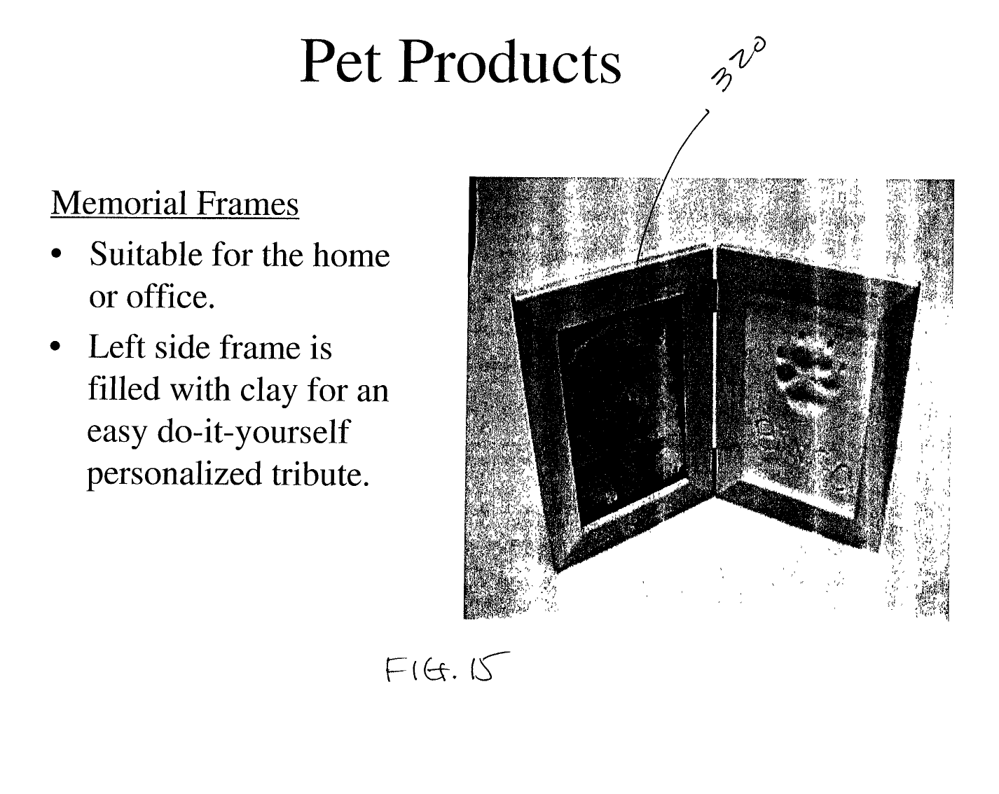

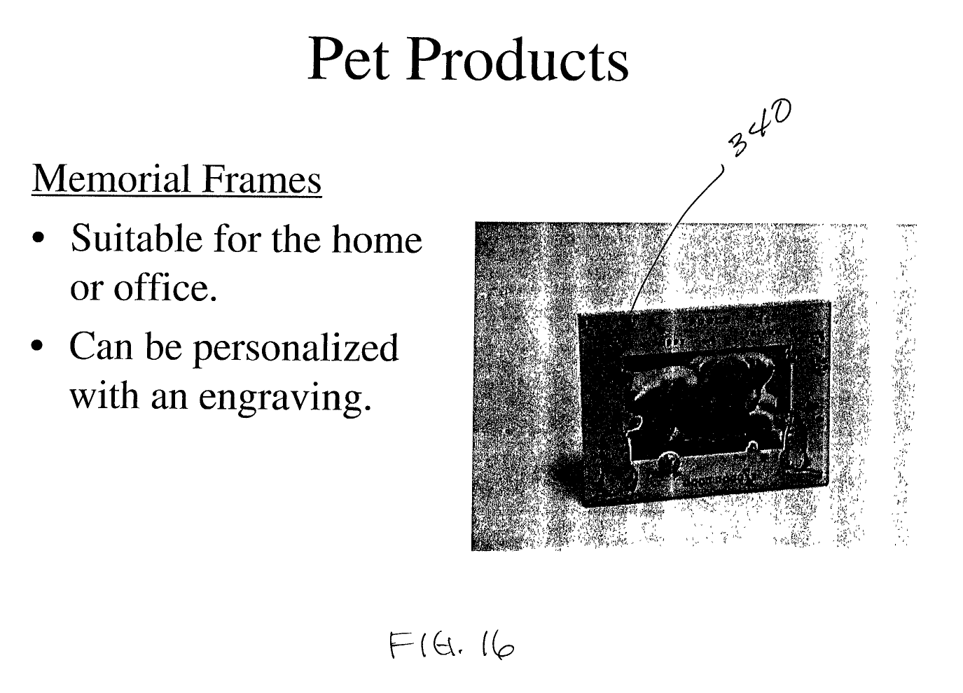

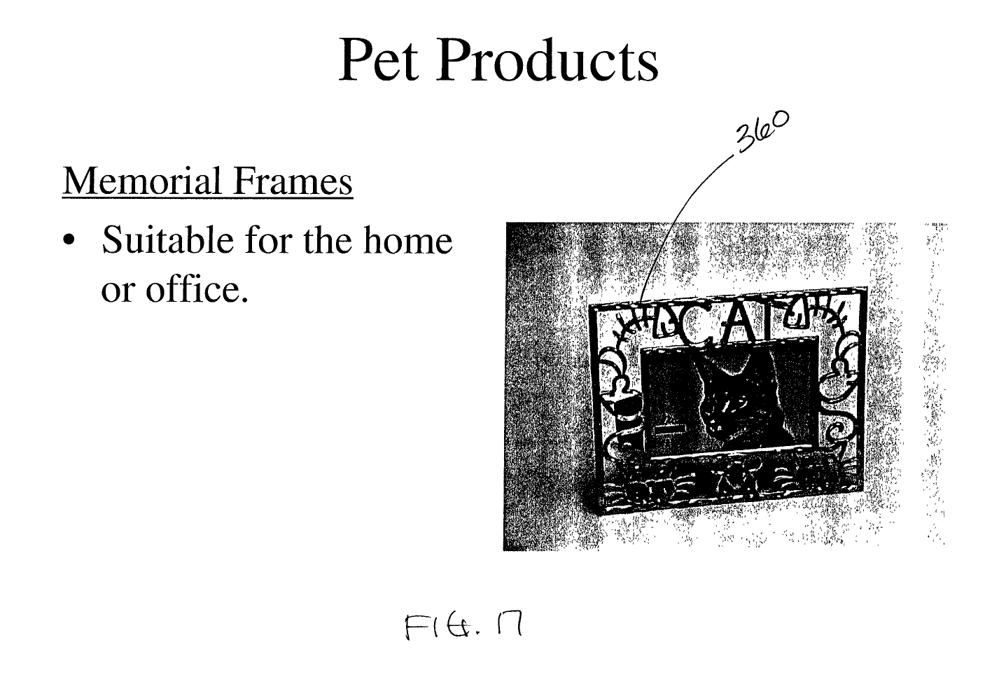

FIGS. 15-17 are pet memorial frames. The FIG. 15 frame 320 includes a picture frame on one side and is filled with clay on the other side facilitating an easy do-it-yourself personalized tribute to one's pet, for example paw print, etc. The frame 320 is suitable for home or office. The FIG. 16 frame 340 can be personalized with an engraving and is likewise suitable for home or office. The FIG. 17 frame 360 is particularly adapted for cats and is also suitable for home or office.

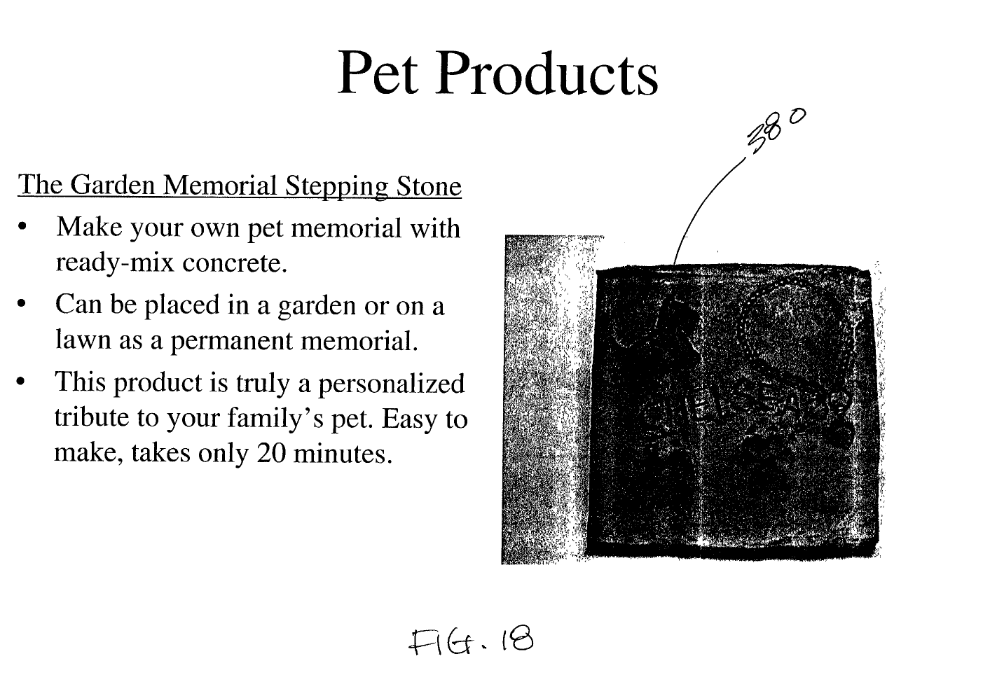

FIG. 18 is a garden memorial stepping stone. The stepping stone 380 is a do-it-yourself create-your-own pet memorial made with ready mix concrete. The stepping stone 380 can be placed in a garden or on a lawn as a permanent memorial to the pet.

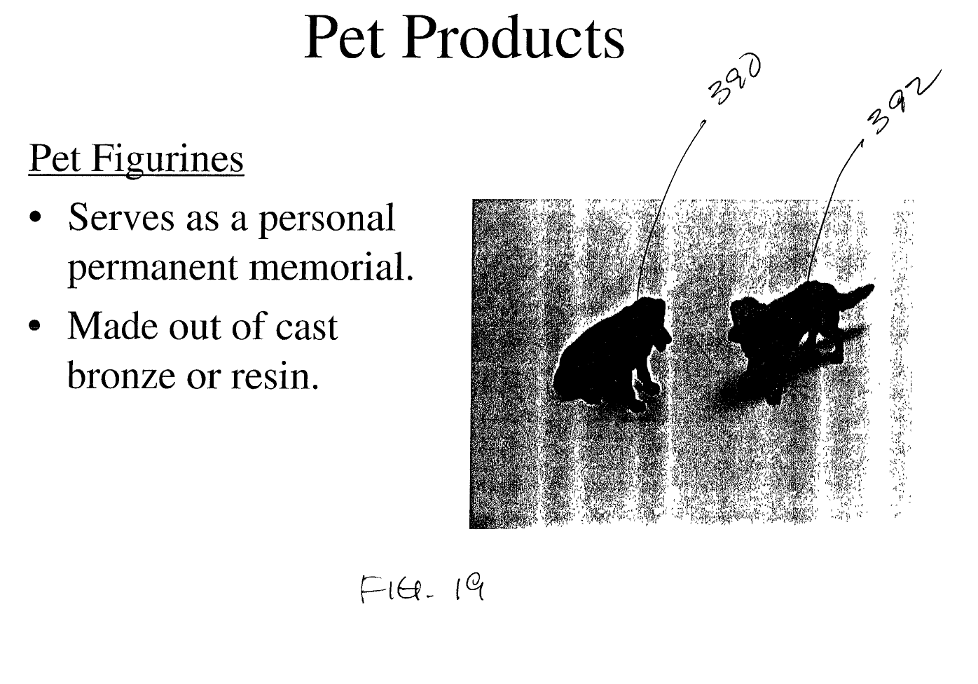

FIG. 19 is pet figurines 390, 392 made out of cast bronze or resin and serving as a personal permanent memorial.

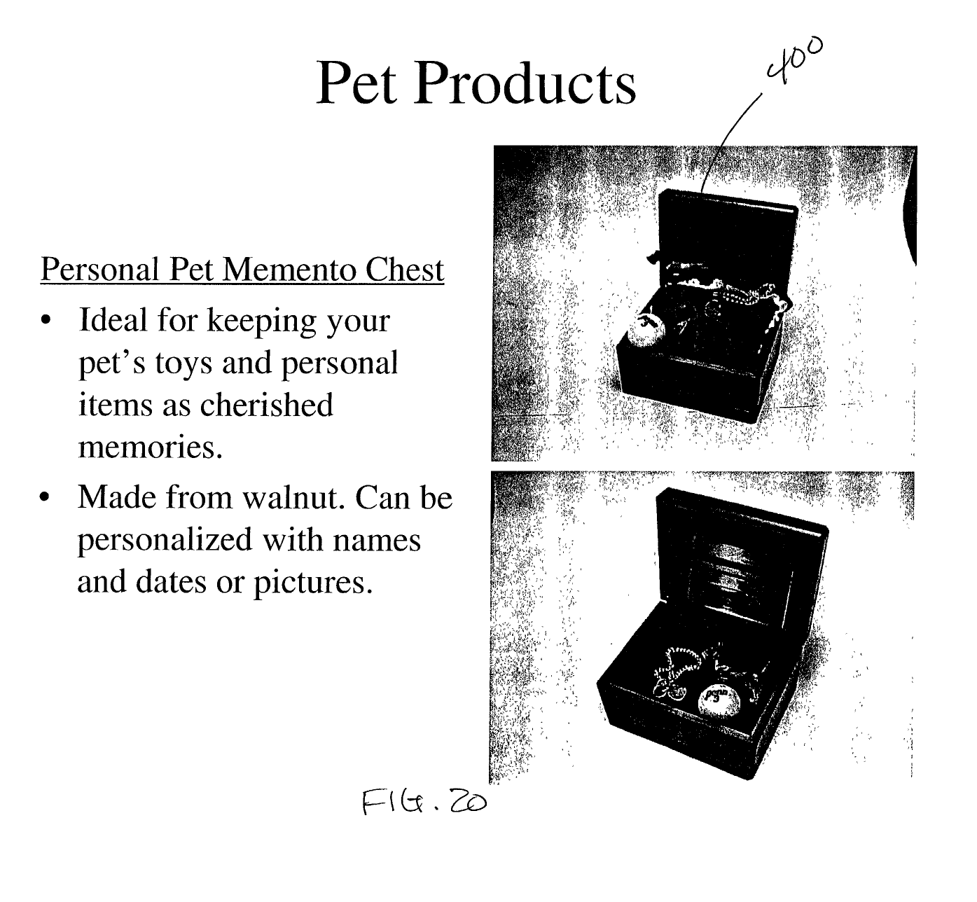

FIG. 20 is a pet memorial chest 400, made from walnut, and personalized with names, dates or pictures. The chest 400 is ideal for keeping a pet's toys and personal items as cherished memories.

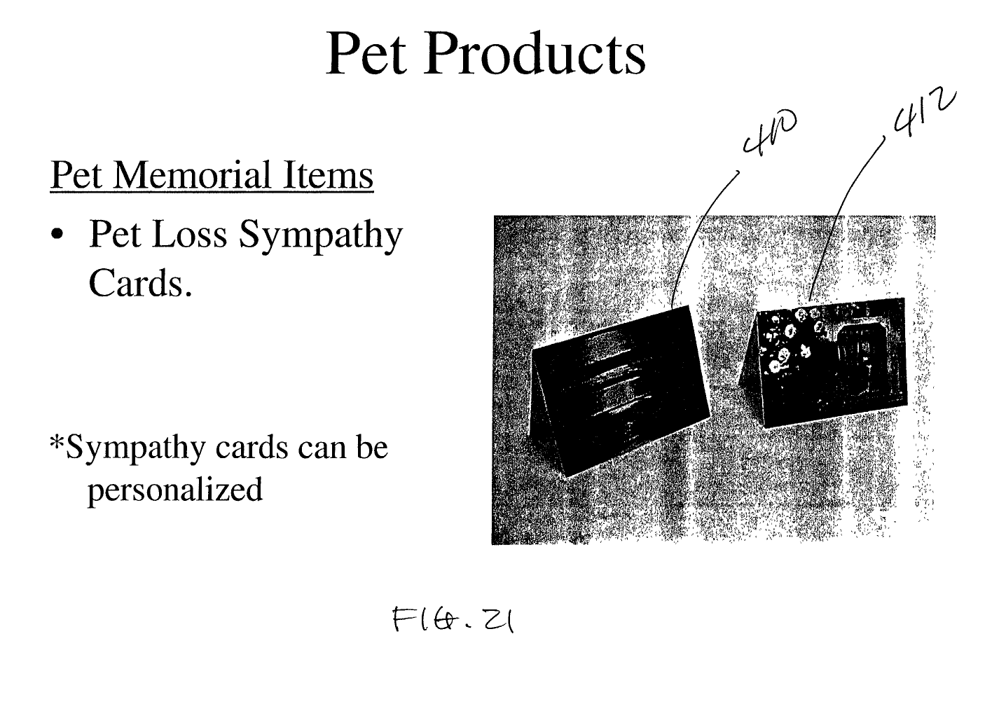

FIG. 21 is pet loss sympathy cards 410 and 412.

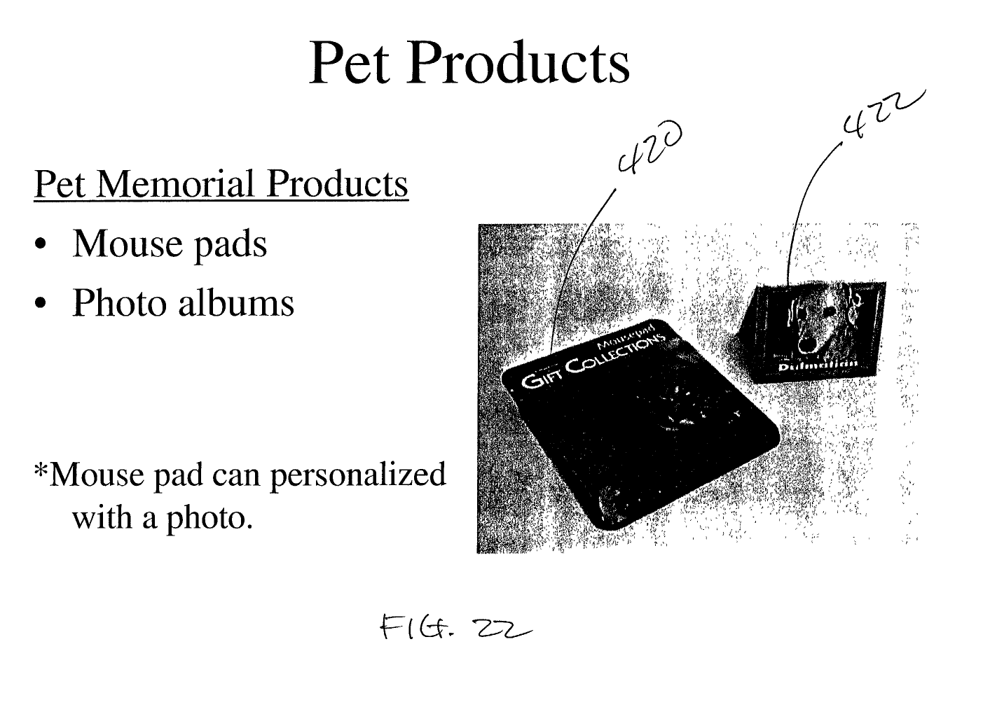

FIG. 22 is a pet memorial mouse pad and a pet memorial photo album 422, both of which can be personalized with a photo.

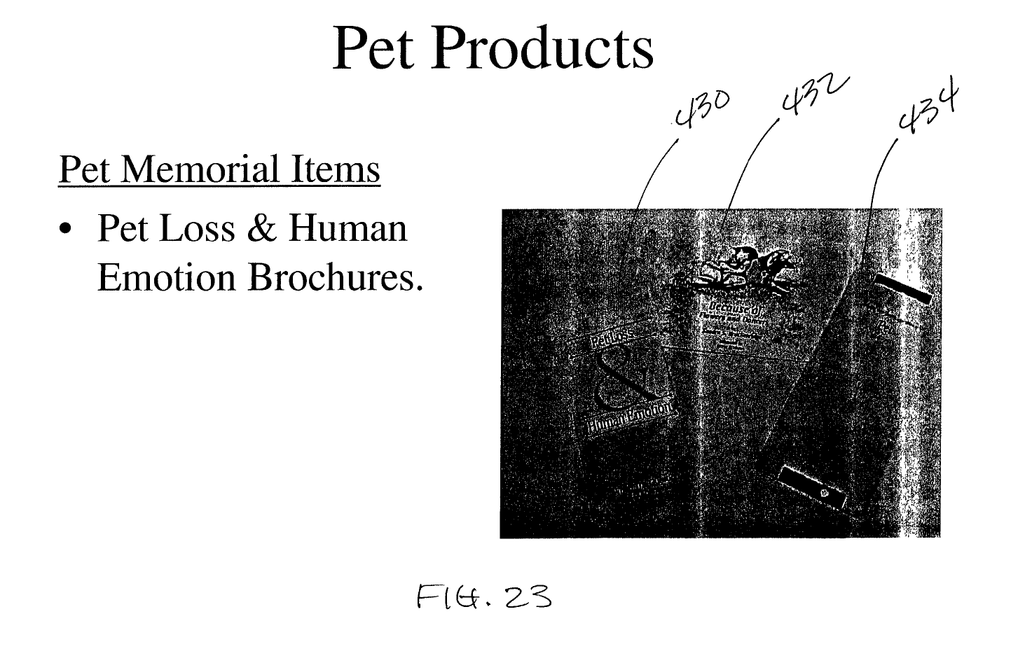

FIG. 23 is pet loss and human emotion brochures 430, 432 and 434.

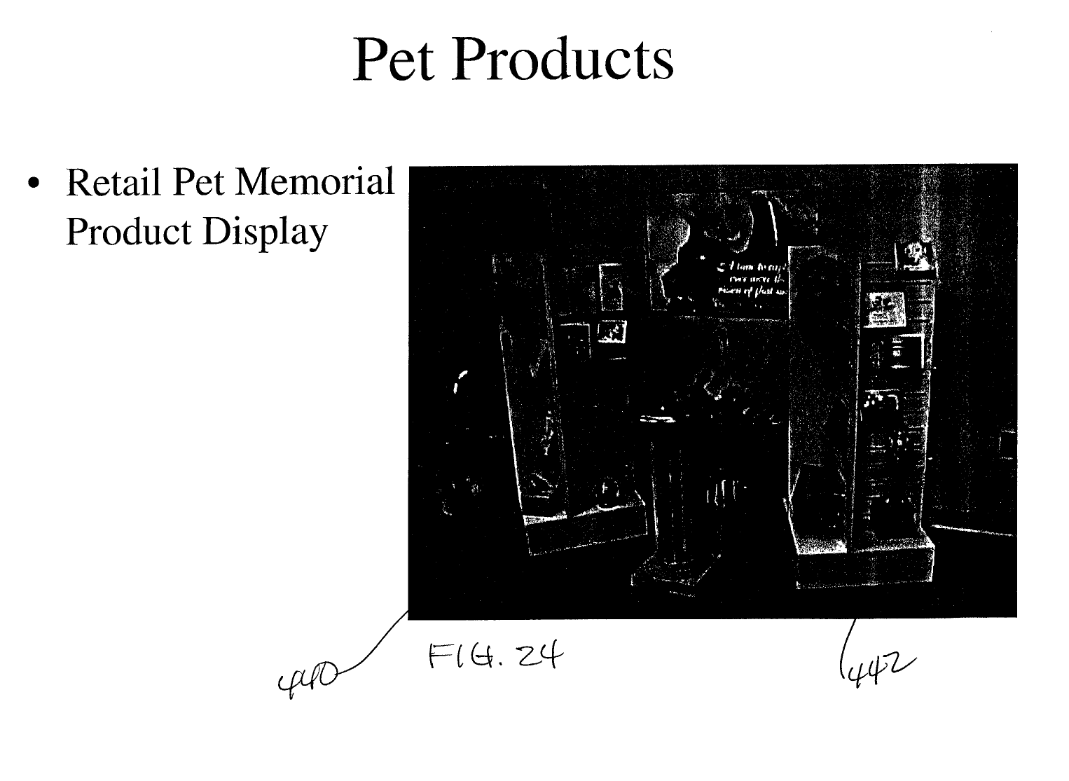

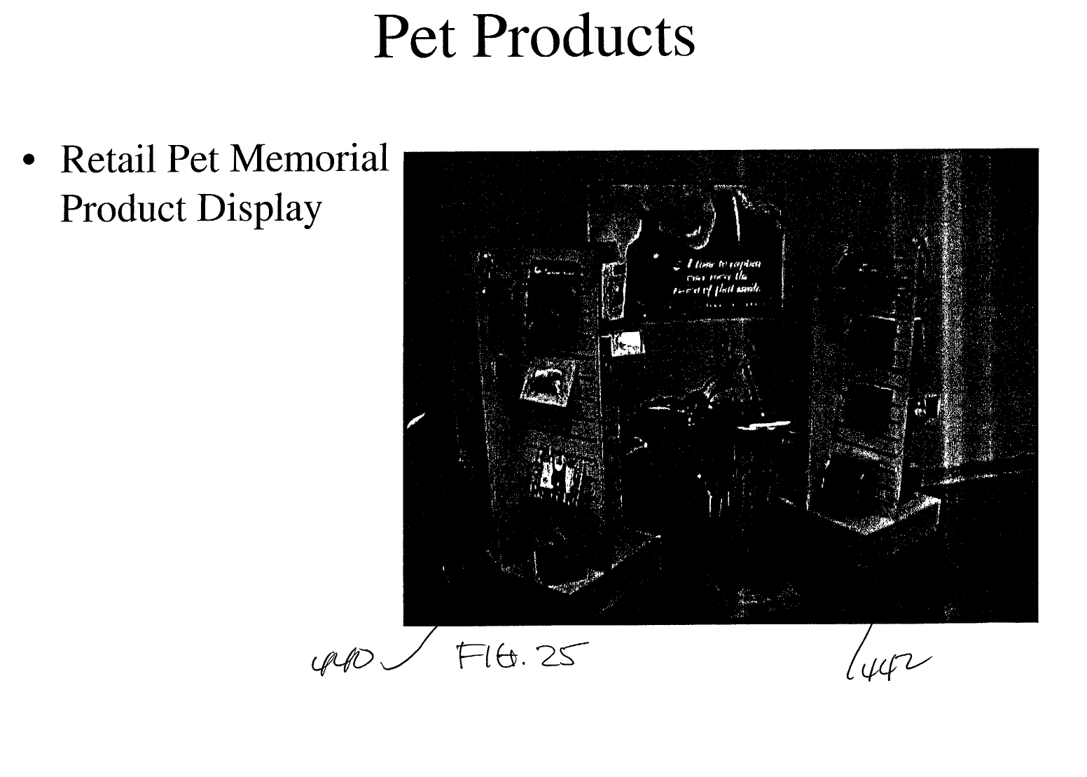

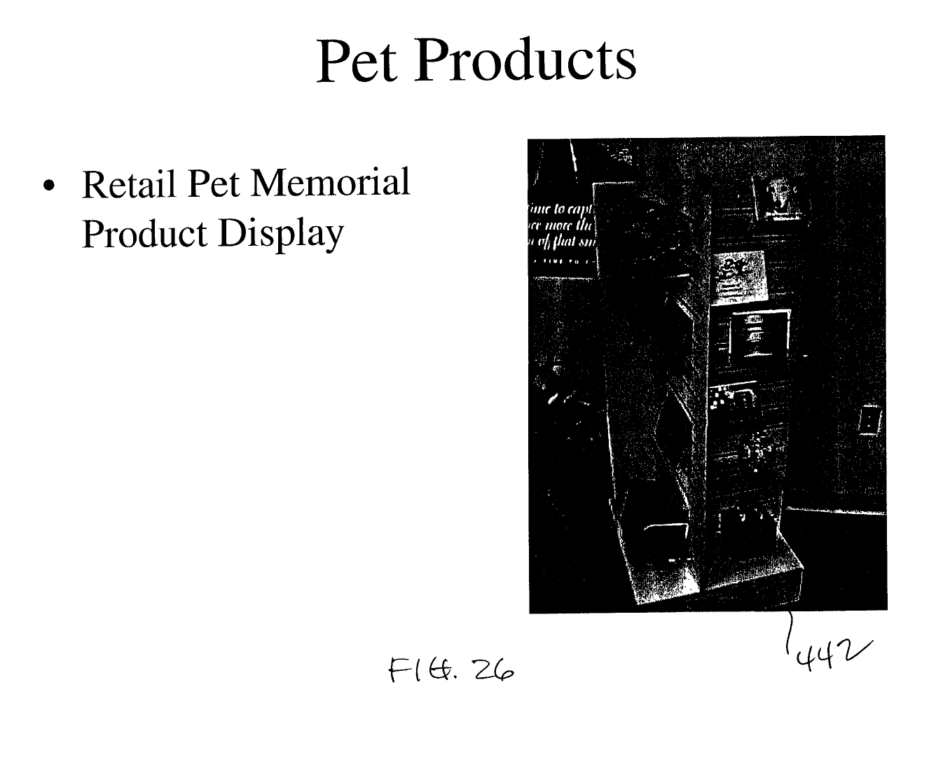

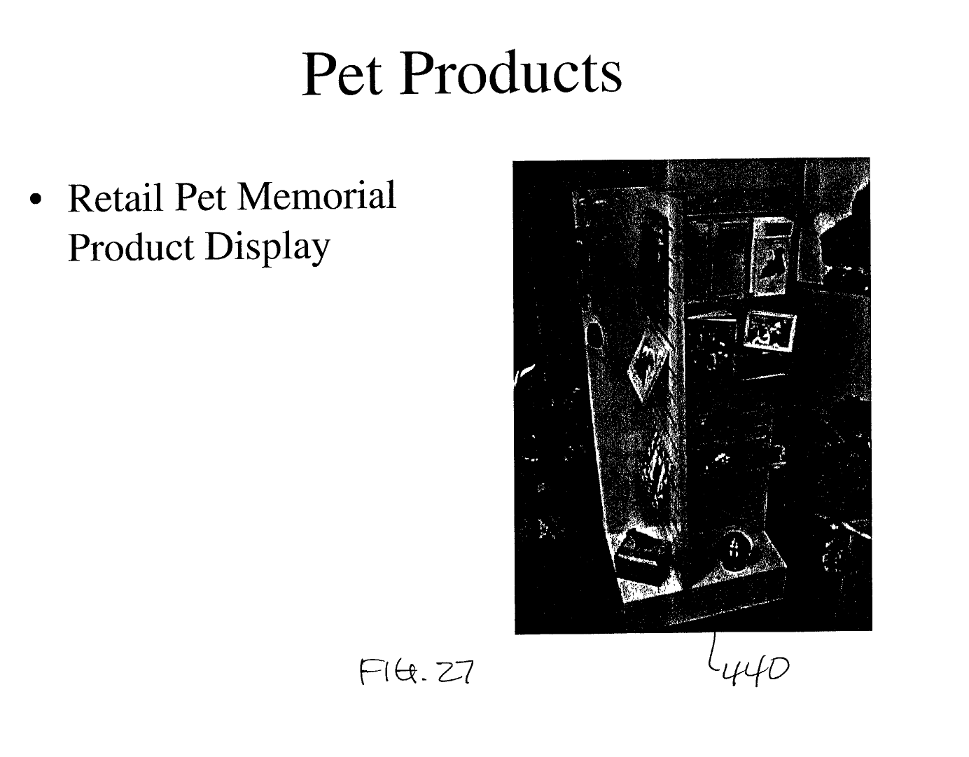

Lastly, FIGS. 24-27 are retail pet memorial product displays including display stands 440 and 442. The pet memorial product displays could be displayed by the preferred provider in a retail setting.

Those skilled in the art will readily recognize numerous adaptations and modifications which can be made to the present invention which will result in an improved method of providing pet death care products, services and information, yet all of which will fall within the spirit and scope of the present invention as defined in the following claims. Accordingly, the invention is to be limited only by the scope of the following claims and their equivalents.

What is claimed is:

1. A method of providing pet death care products, services and information comprising:
receiving pet death care products, services and information from a supplier of pet death care products, services and information; and
as a preferred provider, dispensing the pet death care products, services and information to pet owners.

2. The method of claim 1 wherein the preferred provider is a veterinarian.

3. The method of claim 2 wherein the veterinarian is a network of veterinarians.

4. The method of claim 1 wherein the preferred provider is a pet store.

5. The method of claim 4 wherein the pet store is a nationwide chain of pet stores.

6. The method of claim 1 wherein the preferred provider is a pet cemetery.

7. The method of claim 6 wherein the pet cemetery is a nationwide chain of pet cemeteries.

8. The method of claim 1 wherein the products include pet caskets, urns, memorial markers and products and printed matter.

9. The method of claim 1 wherein the services include cremation and burial, and funeral and memorial services.

10. The method of claim 1 wherein the information includes information about grief counseling and death/grief support groups.

11. A method of equipping a preferred provider with pet death care products, services and information to be dispensed to pet owners comprising:
selecting a preferred provider to dispense pet death care products, services and information to pet owners; and
supplying the preferred provider with pet death care products, services and information to be dispensed by the preferred provider to pet owners.

12. The method of claim 11 wherein the preferred provider is a veterinarian.

13. The method of claim 12 wherein the veterinarian is a network of veterinarians.

14. The method of claim 11 wherein the preferred provider is a pet store.

15. The method of claim 14 wherein the pet store is a nationwide chain of pet stores.

16. The method of claim 11 wherein the preferred provider is a pet cemetery.

17. The method of claim 16 wherein the pet cemetery is a nationwide chain of pet cemeteries.

18. The method of claim 11 wherein the products include pet caskets, urns, memorial markers and products and printed matter.

19. The method of claim 11 wherein the services include cremation and burial, and funeral and memorial services.

20. The method of claim 11 wherein the information includes information about grief counseling and death/grief support groups.

21. The method of claim 1 or 11 wherein the services include cremation performed at a crematory owned by the supplier.

22. The method of claim 1 or 11 wherein the services include cremation performed at a crematory owned by a humane society.

23. The method of claim 1 or 11 wherein the services include cremation performed at a crematory owned by a competitor of the supplier.

24. The method of claim 1 or 11 wherein the services include cremation performed at a crematory owned by a crematory manufacturer.
